(19) United States
(12) Patent Application Publication
(10) Pub. No.: US 2012/0236134 A1
(43) Pub. Date: Sep. 20, 2012

(54) HANDHELD BRAILLE CONVERTING DEVICE, BRAILLE CONVERTING METHOD, BRAILLE CONVERTING PROGRAM, AND STORAGE MEDIUM

(75) Inventor: Anthony Thomas Keyes, Kawagoe (JP)

(73) Assignee: PIONEER CORPORATION, Kanagawa (JP)

(21) Appl. No.: 13/509,468

(22) PCT Filed: Nov. 16, 2009
(86) PCT No.: PCT/JP2009/069439

§ 371 Date: May 18, 2012

(51) Int. Cl. H04N 7/18

(52) U.S. Cl. 348/62; 348/E07.085

(57) ABSTRACT

A handheld Braille converting device includes a Braille display unit, an image capturing element, a character recognition element, a Braille converting element, and a display control element to complete the process from the reading of the characters to the output of the Braille by itself. Also, the device has a size capable of being held by a single hand. The Braille display unit includes multiple single Braille display units each corresponding to one Braille character and each single Braille display unit includes multiple movable members. The display control element displays whether or not the relative position of the handheld Braille converting device is correct with respect to a character or character string existing in the captured image, by operating members included in a part of the single Braille display units. The display control element also displays Braille by operating members included in the other single Braille display units.

### TECHNICAL FIELD

The present invention relates to a method of converting characters to Braille.

### BACKGROUND TECHNIQUE

As a character reading device for a visually handicapped person, there is known a Braille display device which converts electronic data of a line of characters into Braille and displays it.

Patent Reference-1 discloses an electronic data display system which converts text data in a computer into Braille and displays it.

Patent Reference-1:

Japanese Patent Application Laid-open under No. 2003-502699

### DISCLOSURE OF INVENTION

### Problem to be Solved by the Invention

However, there is such a problem in the above Braille recognition device that characters on a printed matter cannot be easily converted into Braille on the spot.

The above is an example of the problem to be solved by the present invention. An object of the present invention is to provide a Braille converting device easily carried by a user and capable of easily converting characters on a printed matter into Braille on the spot.

### Means for Solving the Problem

The invention according to claim 1 is a handheld Braille converting device movable while being held by a user by a single hand, including: a Braille display unit which is arranged at a position capable of being contacted by at least one finger of a hand of the user holding the device and which displays Braille; an image capturing means which captures a predetermined range around the handheld Braille converting device; a character recognition means which detects presence/absence of character(s) existing in an image captured by the image capturing means and recognizes the character(s); a Braille converting means which converts a part of or all the characters recognized by the character recognition means to Braille; and a display control means which displays the Braille converted by the Braille converting means on the Braille display unit, wherein the Braille display unit includes multiple single Braille display units each corresponding to one Braille character; wherein each single Braille display unit includes multiple movable members; and wherein the display control means displays whether or not the relative position of the handheld Braille converting device is correct with respect to a character or character string existing in the captured image, by operating members included in a part of the single Braille display units, and displays Braille by operating members included in the other single Braille display units.

The invention according to claim 9 is a Braille converting method executed by a handheld Braille converting device movable while being held by a user by a single hand and including a Braille display unit which is arranged at a position capable of being contacted by at least one finger of a hand of the user holding the device and which displays Braille, the method including: an image capturing process which captures a predetermined range around the handheld Braille converting device; a character recognition process which detects presence/absence of character(s) existing in an image captured by the image capturing process and recognizes the character(s); a Braille converting process which converts a part of or all the characters recognized by the character recognition process to Braille; and a display control process which displays the Braille converted by the Braille converting process on the Braille display unit, wherein the Braille display unit includes multiple single Braille display units each corresponding to one Braille character; wherein each single Braille display unit includes multiple movable members; and wherein the display control process displays whether or not the relative position of the handheld Braille converting device is correct with respect to a character or character string existing in the captured image, by operating members included in a part of the single Braille display units, and displays Braille by operating members included in the other single Braille display units.

The invention according to claim 10 is a Braille converting program executed by a handheld Braille converting device movable while being held by a user by a single hand and including a Braille display unit which is arranged at a position capable of being contacted by at least one finger of a hand of the user holding the device and which displays Braille, the program making the Braille converting device function as: an image capturing means which captures a predetermined range around the handheld Braille converting device; a character recognition means which detects presence/absence of character(s) existing in an image captured by the image capturing means and recognizes the character(s); a Braille converting means which converts a part of or all the characters recognized by the character recognition means to Braille; and a display control means which displays the Braille converted by the Braille converting means on the Braille display unit, wherein the Braille display unit includes multiple single Braille display units each corresponding to one Braille character; wherein each single Braille display unit includes multiple movable members; and wherein the display control means displays whether or not the relative position of the handheld Braille converting device is correct with respect to a character or character string existing in the captured image, by operating members included in a part of the single Braille display units, and displays Braille by operating members included in the other single Braille display units.

### BRIEF DESCRIPTION OF THE DRAWINGS

FIG. 1 is one example of a block diagram showing a schematic configuration of the handheld Braille converting device.

FIGS. 2A and 2B are examples of block diagrams showing a structure of the handheld Braille converting device.

FIG. 3 is one example of a block diagram showing a functional configuration of the handheld Braille converting device.

FIG. 4 is one example of a top view diagram of the Braille display unit.

FIGS. 5A to 5C are examples of a Braille display and a relative position correctness indication display.

FIGS. 6A to 6C are examples of a Braille display and a relative position correctness indication display.

FIGS. 7A to 7C are examples of a Braille display and a relative position correctness indication display.

FIGS. 8A to 8C are examples of a Braille display and a relative position correctness indication display.

FIGS. 9A and 9B are examples of a Braille display and a relative position correctness indication display.

FIGS. 10A to 10D are examples of a Braille display and a relative position correctness indication display.

FIG. 11 shows one example of a diagram showing boundaries in the horizontal axis direction of each character string in the captured image.

FIG. 12 is one example of a diagram showing a range of each character string in the captured image.

FIG. 13 is one example showing a calculating method of the Braille cell number Ns.

FIGS. 14A to 14D are examples each showing the position of the target character string for Braille and the single Braille display unit to be used.

FIGS. 15A and 15B are examples of diagrams each showing a relative position of the target character string for Braille before and after the movement.

FIG. 16 is one example of a flowchart showing a procedure of the process according to the embodiment.

### DETAILED DESCRIPTION OF THE PREFERRED EMBODIMENTS

According to one aspect of the present invention, there is provided a handheld Braille converting device movable while being held by a user by a single hand, including: a Braille display unit which is arranged at a position capable of being contacted by at least one finger of a hand of the user holding the device and which displays Braille; an image capturing means which captures a predetermined range around the handheld Braille converting device; a character recognition means which detects presence/absence of character(s) existing in an image captured by the image capturing means and recognizes the character(s); a Braille converting means which converts a part of or all the characters recognized by the character recognition means to Braille; and a display control means which displays the Braille converted by the Braille converting means on the Braille display unit, wherein the Braille display unit includes multiple single Braille display units each corresponding to one Braille character; wherein each single Braille display unit includes multiple movable members; and wherein the display control means displays whether or not the relative position of the handheld Braille converting device is correct with respect to a character or character string existing in the captured image, by operating members included in a part of the single Braille display units, and displays Braille by operating members included in the other single Braille display units.

The above handheld Braille converting device includes a Braille display unit, an image capturing means, a character recognition means, a Braille converting means, and a display control means to complete the process from the reading of the characters to the output of the Braille by itself. Also, the device has a size capable of being held by a single hand. Thus, it is possible to provide a Braille converting device which is easily carried by a user and which can easily convert characters around the user to Braille on the spot. The Braille display unit includes multiple single Braille display units each corresponding to one Braille character and each single Braille display unit includes multiple movable members. The member may be a pin or a ball. The display control means displays whether or not the relative position of the handheld Braille converting device is correct with respect to a character or character string existing in the captured image, by operating members included in a part of the single Braille display units. The display control means also displays Braille by operating members included in the other single Braille display units. By being combined with multiple single Braille display units, the handheld Braille converting device can display Braille to guide a user operation. Therefore, it becomes possible to realize a low production cost, a weight saving, and a downsizing of the handheld Braille converting device.

In one mode of the handheld Braille converting device, the single Braille display units are arranged side by side; and a display control unit displays whether or not the relative position of the handheld Braille converting device is correct with respect to a character or character string existing in the captured image, by operating members included in the single Braille display units positioned at both ends. By displaying whether or not the relative position of the handheld Braille converting device is correct by the single Braille display units positioned at both ends, the handheld Braille converting device can clearly inform the user of a target direction to be guided.

In another mode of the handheld Braille converting device, the display control means indicates in which direction the position of the handheld Braille converting device is shifted with respect to the character or the character string existing in the captured image, by operating the members included in the part of the single Braille display units. In this mode, when the handheld Braille converting device cannot properly read a character, the user can recognize in which direction the position of the handheld Braille converting device is shifted with respect to the character or the character string by checking the operation of the members with their finger tips.

In still another mode of the handheld Braille converting device, the display control means indicates the presence/absence of character(s) in the captured image, by operating the members included in the part of the single Braille display units. In this mode, the user can recognize the presence/absence of character(s) in the captured image by checking the operation of the members with their finger tips. When Braille is not displayed even though character(s) exist in the captured image, the user can know that the character(s) cannot be recognized or converted to Braille.

In still another mode of the handheld Braille converting device, the display control means indicates whether the character string existing in the captured image is written vertically or horizontally, by operating the members included in the part of the single Braille display units. In this mode, by checking the operation of the members with their finger tips, the user can judge whether the character string existing in the captured image is written vertically or horizontally, thereby allowing them to move the Braille converting device in the correct direction.

In still another mode of the handheld Braille converting device, the display control means indicates a direction of an initial character of the character string existing in the captured image, by operating the members included in the part of the single Braille display units. The expression “initial character” herein indicates a character which the user is supposed to read at first in character string existing in the captured image. In this mode, by checking the operation of the members with their finger tips, the user can move the handheld Braille converting device in the direction of the initial character in the character string existing in the captured image.

In still another mode of the handheld Braille converting device, the display control means displays whether or not the relative position is correct by lifting up and lowering the members included in the part of the single Braille display units to form the convex shapes while vibrating the members, and displays Braille by lifting up and lowering the members included in the other part of the single Braille display units to form the convex shapes. In this mode, the user can clearly discern the part displaying whether or not the relative position is correct from the part displaying Braille in the Braille display unit.

In still another mode of the handheld Braille converting device, the Braille converting means calculates an average character width of each character constituting character string to be displayed as Braille, and calculates the number of the Braille corresponding to the character string; and the display control means shifts a display of Braille based on the average character width and the number of the Braille when the handheld Braille converting device has moved. In this mode, the display control means redisplays Braille on the basis of the average character width of the character and the number of the Braille characters corresponding to the character string in its entirety. The expression “the number of the Braille characters” herein indicates the number of times for displaying Braille when the Braille of the character string in its entirety is displayed by one single Braille display unit. Thereby, the handheld Braille converting device can display the Braille of the character string at an average interval while moving and reading the character string even when a character which needs more than one Braille characters such as a Chinese character is included in the character string.

According to another aspect of the present invention, there is provided a Braille converting method executed by a handheld Braille converting device movable while being held by a user by a single hand and including a Braille display unit which is arranged at a position capable of being contacted by at least one finger of a hand of the user holding the device and which displays Braille, the method including: an image capturing process which captures a predetermined range around the handheld Braille converting device; a character recognition process which detects presence/absence of character(s) existing in an image captured by the image capturing process and recognizes the character(s); a Braille converting process which converts a part of or all the characters recognized by the character recognition process to Braille; and a display control process which displays the Braille converted by the Braille converting process on the Braille display unit, wherein the Braille display unit includes multiple single Braille display units each corresponding to one Braille character; wherein each single Braille display unit includes multiple movable members; and wherein the display control process displays whether or not the relative position of the handheld Braille converting device is correct with respect to a character or character string existing in the captured image, by operating members included in a part of the single Braille display units, and displays Braille by operating members included in the other single Braille display units. By using the above method, the handheld Braille converting device can easily convert characters around the user to Braille on the spot.

According to still another aspect of the present invention, there is provided a Braille converting program executed by a handheld Braille converting device movable while being held by a user by a single hand and including a Braille display unit which is arranged at a position capable of being contacted by at least one finger of a hand of the user holding the device and which displays Braille, the program making the Braille converting device function as: an image capturing means which captures a predetermined range around the handheld Braille converting device; a character recognition means which detects presence/absence of character(s) existing in an image captured by the image capturing means and recognizes the character(s); a Braille converting means which converts a part of or all the characters recognized by the character recognition means to Braille; and a display control means which displays the Braille converted by the Braille converting means on the Braille display unit, wherein the Braille display unit includes multiple single Braille display units each corresponding to one Braille character; wherein each single Braille display unit includes multiple movable members; and wherein the display control means displays whether or not the relative position of the handheld Braille converting device is correct with respect to a character or character string existing in the captured image, by operating members included in a part of the single Braille display units, and displays Braille by operating members included in the other single Braille display units. By executing the above Braille converting program, the handheld Braille converting device can easily convert characters around the user to Braille on the spot. In a preferred example, the above Braille converting program is stored in a recording medium.

### Embodiment

A preferred embodiment of the present invention will be described below with reference to the attached drawings.

[Configuration]

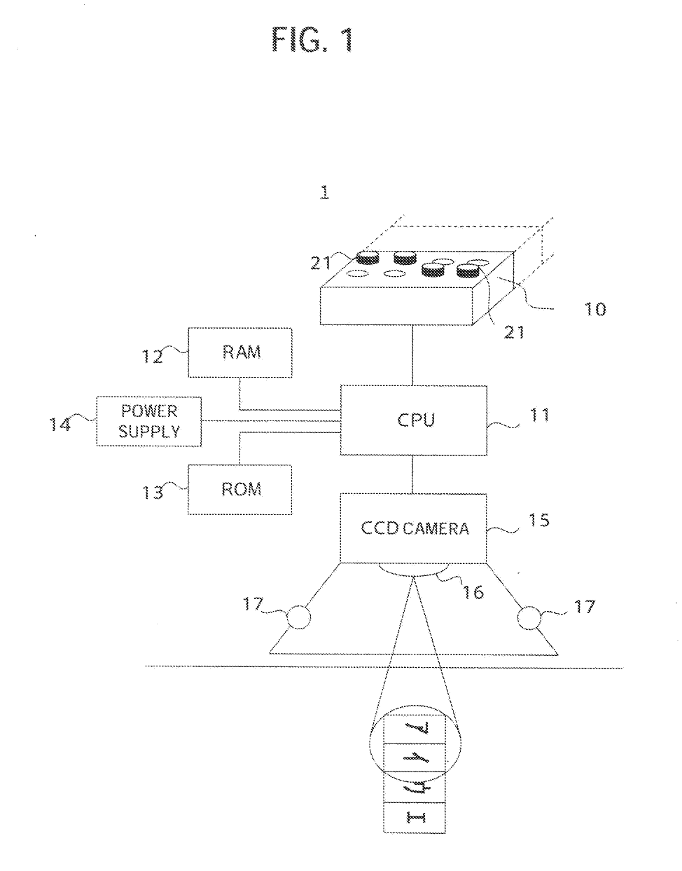

First, a configuration of a handheld Braille converting device 1 according to an embodiment of the present invention will be described with reference to FIGS. 1 to 4.

(Hardware Configuration)

FIG. 1 schematically shows a configuration of the handheld Braille converting device 1 according to an embodiment of the present invention. As shown, the handheld Braille converting device 1 includes a Braille display unit 10, a CPU 11, a RAM 12, a ROM 13, a power supply 14, a camera 15, a lens 16 and a lighting LED 17.

The Braille display unit 10 has multiple movable pins 21 as shown, and displays Braille by lifting up and lowering the pins to form convex shapes. The detail of the arrangement of the movable pins 21 will be described later.

When a user puts the handheld Braille converting device 1 on a printed matter, the camera 15 captures a predetermined range around the handheld Braille converting device 1, and transmits a captured image to the CPU 11. For example, the camera 15 may be a CCD camera.

By executing a program stored beforehand in the RAM 12 or the ROM 13, the CPU 11 detects the presence/absence of character(s) in the captured image obtained from the camera 15, and executes OCR (Optical Character Recognition) processing to recognize the characters if there are characters. For non-Alphabetic characters, e.g. Chinese, the CPU 11 refers to dictionary information associating non alphabetic characters with their pronunciation and Braille definition information associating each pronunciation or each character with its Braille equivalent, stored in the memory such as the RAM 12 and the ROM 13, and converts the recognized characters to Braille. Then, the CPU 11 displays the converted Braille on the Braille display unit 10.

The power supply 14 supplies the power to the handheld Braille converting device 1. The lens 16 is a lens of the camera, and the lighting LED 17 is a light source which is necessary for the camera 15 to capture the characters.

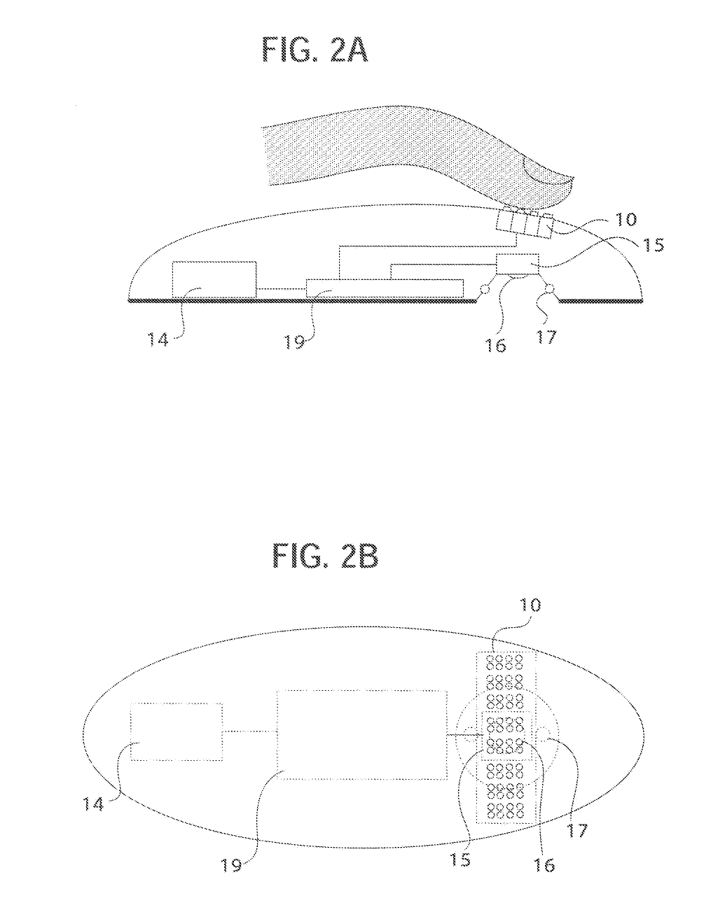

FIGS. 2A and 2B show the structure of the handheld Braille converting device 1 according to the embodiment of the present invention. FIG. 2A is a cross-section side-view showing the internal structure of the handheld Braille converting device 1, and FIG. 2B is a bird's-eye view showing the internal structure of the handheld Braille converting device 1 by broken lines. The handheld Braille converting device 1 is a handheld type device which the user can move by holding with a single hand, and includes the Braille display unit 10, the power supply 14, the camera 15, the lens 16, the lighting LED 17 and a system controller 19 in its inside. The camera 15 and the system controller 19, the system controller 19 and the Braille display unit 10, and the system controller 19 and the power supply 14 are electrically connected by wiring, respectively.

The Braille display unit 10 is arranged at the position where at least one of the first to third fingers can contact the Braille display unit 10 when the user holds the handheld Braille converting device 1 by the thumb and the little finger of a single hand.

The camera 15, the lens 16 and the lighting LED 17 are arranged in and around the area directly-below the Braille display unit 10. In this embodiment, the expression “in and around the area directly-below” includes the area which is just below the Braille display unit 10 and the area within a predetermined distance from this area. The predetermined distance is 3 cm, for example.

The system controller 19 includes the CPU 11, the RAM 12 and the ROM 13, and controls the handheld Braille converting device 1 in its entirety. The power supply 14 may be a battery, for example, and supplies the power to the system controller 19 and also to each part of the handheld Braille converting device 1 via the system controller 19. It is noted that the power supply 14 may directly supply the power to each of the parts without passing the system controller 19.

(Functional Configuration)

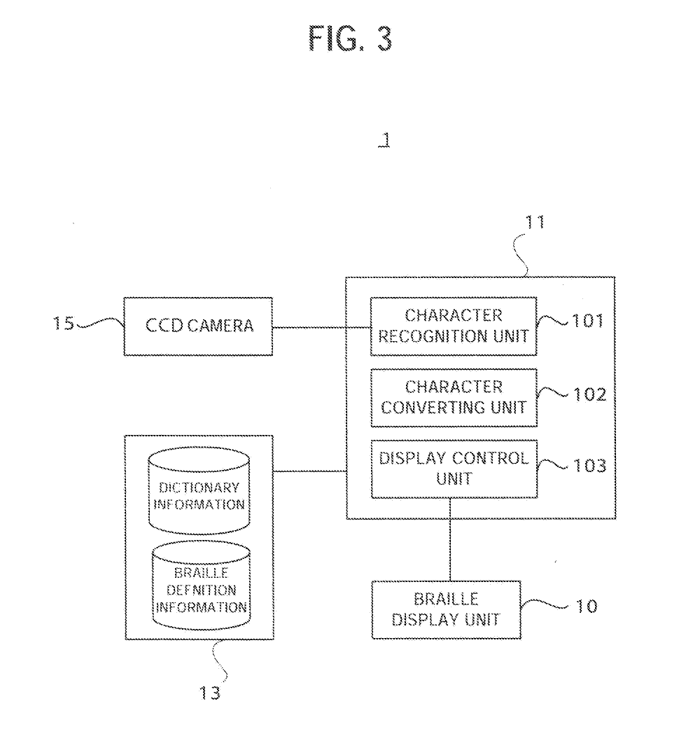

FIG. 3 is a block diagram showing the functional configuration of the handheld Braille converting device 1 of this embodiment. These functions are realized by the components shown in FIG. 1.

The handheld Braille converting device 1 includes the camera 15, the CPU 11, the ROM 13 and the Braille display unit 10 as described above. The CPU 11 executes the program prepared in advance to function as a character recognition unit 101, a Braille converting unit 102 and a display control unit 103. The ROM 13 stores the dictionary information and the Braille definition information. A part of the dictionary information and the Braille definition information may be stored in the RAM 12.

The camera 15 captures the predetermined range around the handheld Braille converting device 1, and transmits the captured image to the CPU 11. The camera 15 functions as the image capturing means in the present invention.

The character recognition unit 101 detects the presence/absence of the characters in the captured image received from the camera 15, and executes the OCR processing to recognize the characters if there are characters. The character recognition unit 101 obtains information of a relative position (hereinafter simply referred to as “position Pr”) of recognized character string when regarding the captured image as a two dimensional coordinate plane with a vertical axis and a horizontal axis, and also obtains information of an angle (hereinafter simply referred to as “angle Θr”) which the straight line along the character string makes with respect to the horizontal axis in the two dimensional coordinate, and information of a length (hereinafter referred to as “character string length Lr”) of the character string.

When the character recognized by the character recognition unit 101 is a Chinese character, the Braille converting unit 102 first converts the Chinese character to the pronunciation based on the dictionary information associating the Chinese character with its pronunciation, and then converts the pronunciation to Braille based on the Braille definition information associating the pronunciation with its Braille equivalent. When the character recognized by the character recognition unit 101 is a hiragana character, a katakana character, a numeral or an alphabet, the Braille converting unit 102 converts them to Braille based on the Braille definition information associating them with their Braille equivalent. The Braille converting unit 102 may convert all the detected characters to Braille, or may convert only a part of the detected characters (e.g., only the number of characters displayable on the Braille display unit 10) to their Braille equivalent. Then, the Braille converting unit 102 supplies the information (hereinafter referred to as “Braille information”) of the converted Braille equivalent to the display control unit 103.

The display control unit 103 displays the Braille converted by the Braille converting unit 102 on the Braille display unit 10. Additionally, the display control unit 103 indicates whether or not the current position of the handheld Braille converting device 1 is proper, and displays a display (hereinafter referred to as “relative position correctness indication display”) for guiding the moving direction to a proper direction on the Braille display unit 10 if needed. Hereinafter, the expression “lift up the movable pins 21” indicates that the display control unit 103 lifts up the movable pins 21 thereby to form the convex shapes.

The Braille display unit 10 executes the Braille display and the relative position correctness indication display by lifting up and lowering the movable pins 21 to form the convex shapes as described above.

(Configuration of Braille Display Unit)

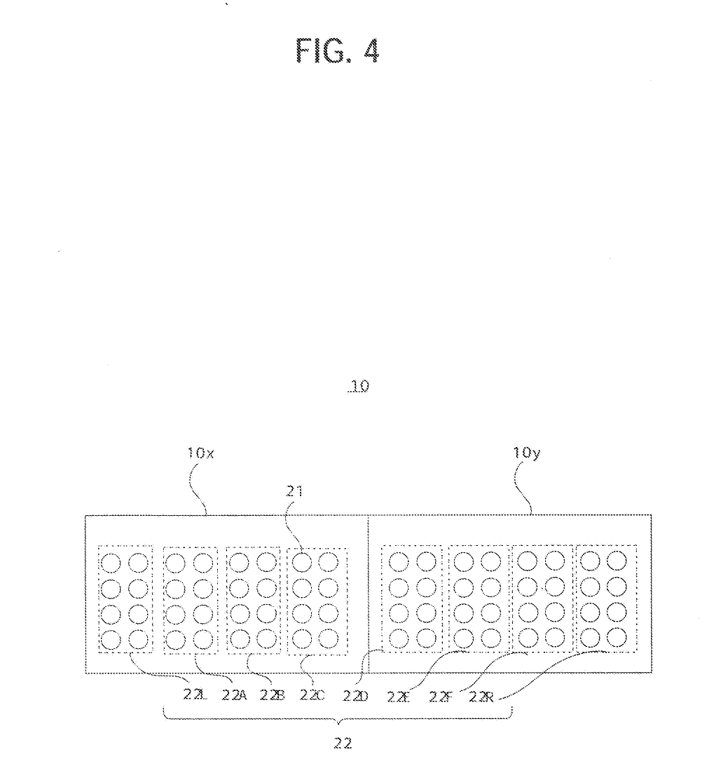

Next, the configuration of the Braille display unit 10 will be described with reference to FIG. 4. FIG. 4 shows the top view diagram of the Braille display unit 10.

The Braille display unit 10 includes a primary Braille module 10x and a secondary Braille module 10y. Each of the primary Braille module 10x and the secondary Braille module 10y has thirty-two movable pins 21. Namely, the primary Braille module 10x and the secondary Braille module 10y are arranged side by side so that total sixty-four movable pins 21 are arranged on the Braille display unit 10.

Total eight movable pins 21 arranged in two columns and four rows constitute one single Braille display unit 22. Therefore, total eight single Braille display units 22L, 22A to 22F, 22R are laterally arranged on the Braille display unit 10.

Among them, the single Braille display units 22A to 22F correspond to Braille display parts. Concretely, each of the single Braille display units 22A to 22F lifts up and lowers the eight movable pins 21 and lets them form convex shapes thereby to display Braille. One or two of the single Braille display units 22A to 22F indicates a single character. Hereinafter, the movable pins 21 arranged on the single Braille display units 22A to 22F are referred to as “primary pins”.

In contrast, the single Braille display units 22L and 22R display presence/absence of character(s) and execute the relative position correctness indication display by lifting up and lowering a part of or all the movable pins 21 to form the convex shapes. Thereby, the single Braille display units 22L, 22R let the camera 15 properly capture the target character string to be read, and guides the user operation of moving the handheld Braille converting device 1. Hereinafter, the movable pins 21 arranged on the single Braille display units 22L and 22R are referred to as “secondary pins”.

[Control of Moving Second Pins]

Next, a description will be given of a control method of the secondary pins executed by the display control unit 103. Summarily, the display control unit 103 guides a moving direction (Hereinafter, simply referred to as “moving direction”) of the handheld Braille converting device 1 by lifting up the secondary pins. Concretely, in principle, the display control unit 103 lifts up the secondary pins existing in the direction where the moving direction is supposed to be changed, and lowers the secondary pins existing in the other directions, for the fingers that the user puts on the handheld Braille converting device 1. In this case, it is assumed that the direction of the target character string to be read is kept unchanged. Namely, instead of changing the direction of the printed matter where the target character string is described, the user modifies the moving direction of the handheld Braille converting device 1.

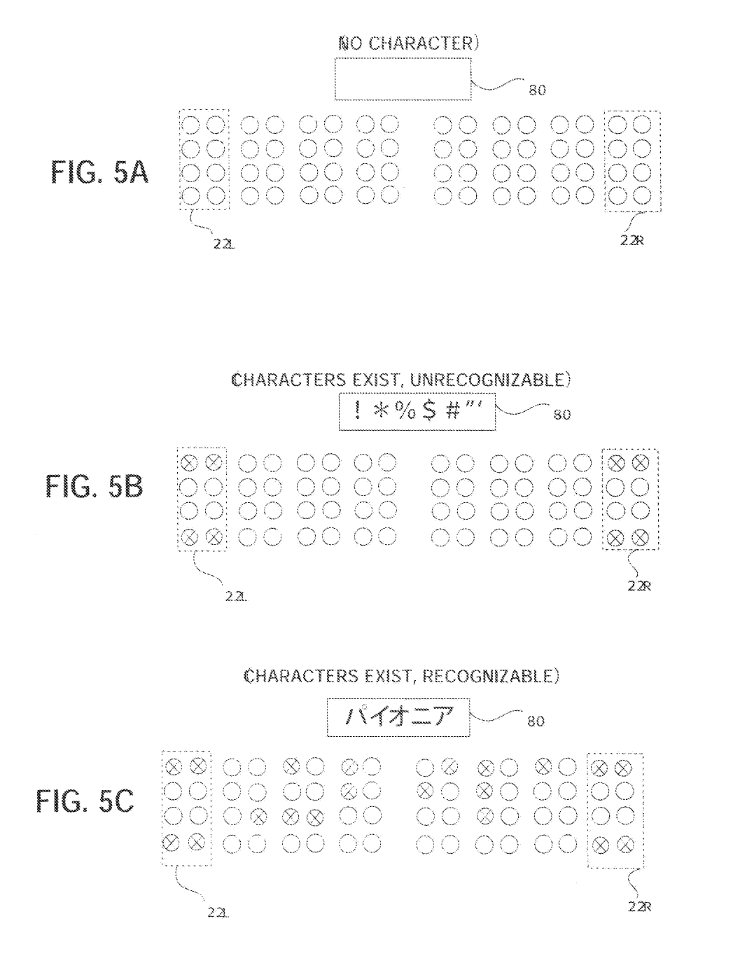

Hereinafter, this concrete examples (first example to fifteen example) classified into fifteen patterns will be described with reference to FIGS. 5 to 10.

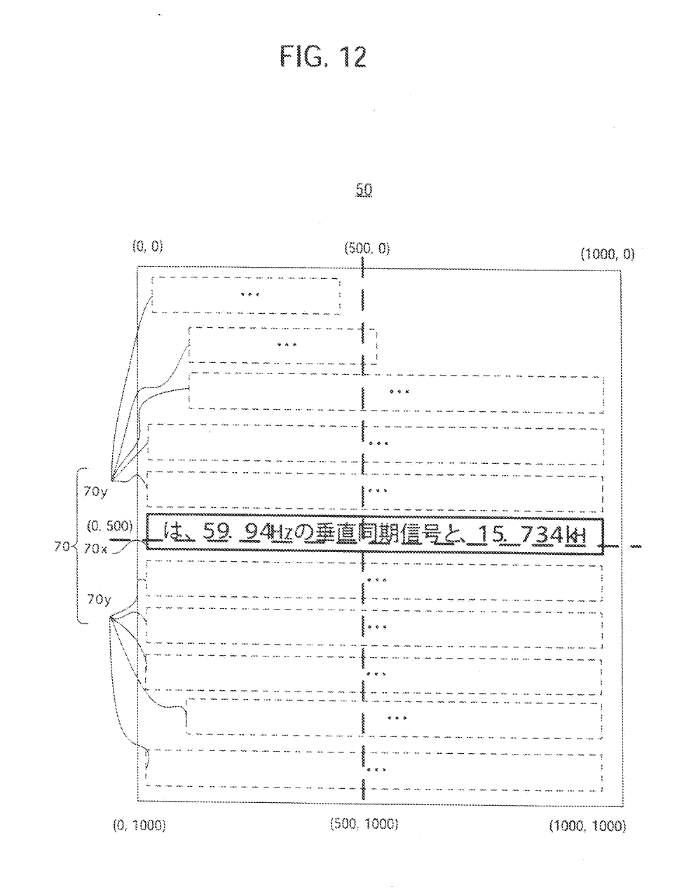

In FIGS. 5 to 10, the non-protruding pin is represented by a white circle “^{o}”, and the protruding pin is represented by a “^{x}” within the white circle “^{o}”. Also, the square frame 80 in the drawings indicates a range of a character or character string (hereinafter referred to as “target character(s) for Braille”) which is converted to Braille equivalent. Hereinafter, the expression “horizontal axis direction” indicates the longer direction of the square frame 80, and coincides with the direction of the horizontal axis which defines the x-coordinate in the captured image mentioned later with reference to FIG. 12. Each of the movable pins 21 arranged in two columns and four rows on the single Braille display units 22L and 22R is specified by a column number which is assigned from left to right and a row number which is assigned from the top.

1. Target Character(s) for Braille Does not Exist

FIG. 5A shows a state of the movable pins 21 in the case where the target character(s) for Braille does not exist. As shown in FIG. 5A, in this case, the display control unit 103 does not lift up any of the secondary pins.

2. Target character(s) for Braille Exists but Unrecognizable

FIG. 5B shows a state of the movable pins 21 in the case where the target characters for Braille are not included in the Braille definition information. As shown in FIG. 5B, in this case, the display control unit 103 lifts up the secondary pins which correspond to the four corners of the single Braille display unit 22L in the first row and the fourth row, and also lifts up the secondary pins which correspond to the four corners of the single Braille display unit 22R in the first row and the fourth row.

3. Target Character(s) for Braille Exists and Recognizable

FIG. 5C shows a state of the movable pins 21 in the case where the target characters for Braille are included in the Braille definition information and can be displayed by Braille. As shown in FIG. 5C, in this case, the display control unit 103 displays the Braille of the target characters for Braille [symbol] by the primary pins on the single Braille display units 22A to 22F, based on the Braille information supplied from the Braille converting unit 102. Concretely, according to each position of the target characters for Braille, the display control unit 103 displays the Braille of [symbol] by the single Braille display units 22A and 22B, and displays the Braille of [symbol] by the single Braille display unit 22C. The display control unit 103 also displays the Braille of [symbol] by the single Braille display unit 22D, the Braille of [symbol] by the single Braille display unit 22E, and displays the Braille of [symbol] by the single Braille display unit 22F.

Additionally, the display control unit 103 lifts up the secondary pins corresponding to the four corner of the single Braille display unit 22L in the first row and the fourth row, and lifts up the secondary pins corresponding to the four corner of the single Braille display unit 22R in the first row and the fourth row.

4. Target Character(s) for Braille Exists and Corresponds to Last Character(s) in Row

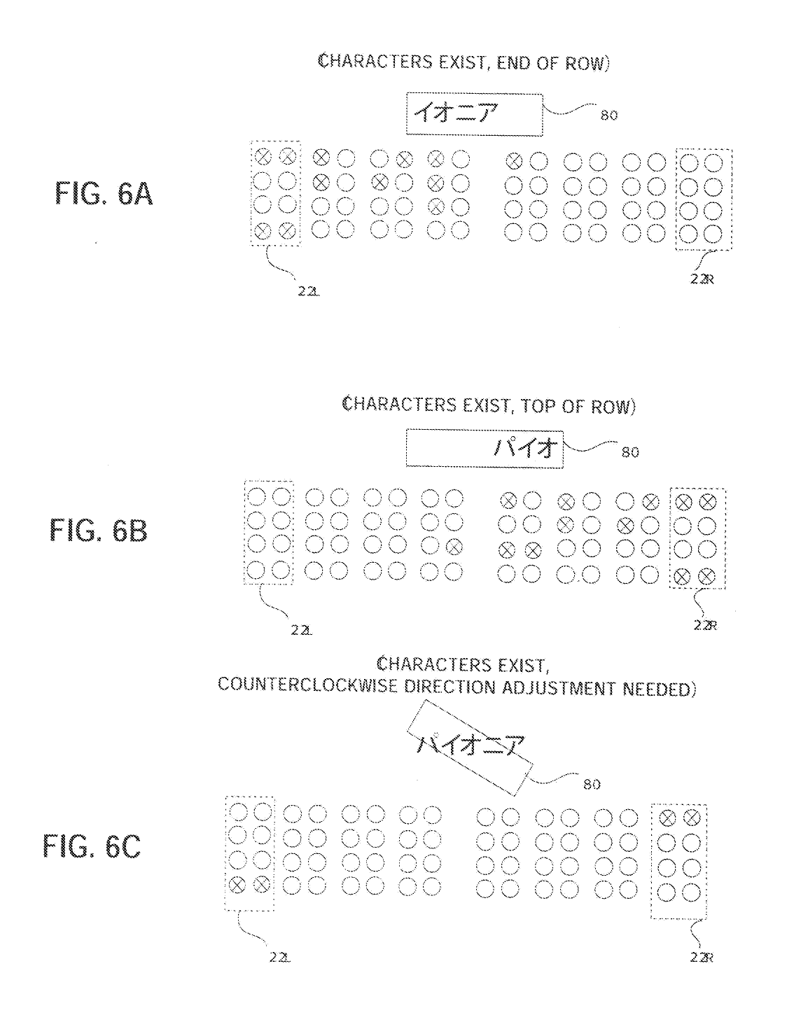

FIG. 6A shows a state of the movable pins 21 in the case where the target characters for Braille correspond to the last characters in the row. As shown in FIG. 6A, in this case, the display control unit 103 displays the Braille of the target characters for Braille [symbol] by the primary pins on the single Braille display unit 22A to 22D. The display control unit 103 informs the user that the target characters for Braille is the last characters by lifting up only the secondary pins at the four corners of the single Braille display unit 22L among the secondary pins on the single Braille display units 22L and 22R.

5. Target Character(s) for Braille Exists and Corresponds to First (Front Edge) Character(s) in Row

FIG. 6B shows a state of the movable pins 21 in the case where the target characters for Braille correspond to the front edge characters in the row. As shown in FIG. 6B, in this case, the display control unit 103 displays the Braille of the target characters for Braille [symbol] by the primary pins on the single Braille display unit 22C to 22F according to their positions. The display control unit 103 also informs the user that the target characters for Braille are the front edge characters by lifting up only the secondary pins at the four corners of the single Braille display unit 22R among the secondary pins on the single Braille display units 22L and 22R.

6. Target Character(s) for Braille Exists and Angle Needs to be Adjusted to Counterclockwise Direction

FIG. 6C shows a state of the movable pins 21 in the case where the movable pins 21 cannot display Braille because the horizontal axis direction of the captured image deviates from the lateral direction of the target characters for Braille by a predetermined angle (hereinafter referred to as “angle Θth”) or greater in the clockwise direction. Here, the angle Θth is 20, for example, and indicates such an angle that the character recognition unit 101 cannot correctly recognize the target character(s) for Braille. In this case, among all the movable pins 21, the display control unit 103 lifts up the two secondary pins in the fourth row of the single Braille display unit 22L, and also lifts up the two secondary pins in the first row of the single Braille display unit 22R. Namely, by lifting up the secondary pins on the downside of the single Braille display unit 22L, the display control unit 103 indicates that the left side of the handheld Braille converting device 1 needs to be moved downward, and by lifting up the secondary pins on the upside of the single Braille display unit 22R, the display control unit 103 indicates that the right side of the handheld Braille converting device 1 needs to be moved upward. Thereby, the display control unit 103 instructs the user operation so that the moving direction of the handheld Braille converting device 1 is rotated in the counterclockwise direction to coincide with the character string. In response, the user moves the left side of the handheld Braille converting device 1 downward and moves the right side of the handheld Braille converting device 1 upward thereby to correct the moving direction of the handheld Braille converting device 1 to the counterclockwise direction.

7. Target Character(s) for Braille Exists and Angle Needs to be Adjusted to Clockwise Direction

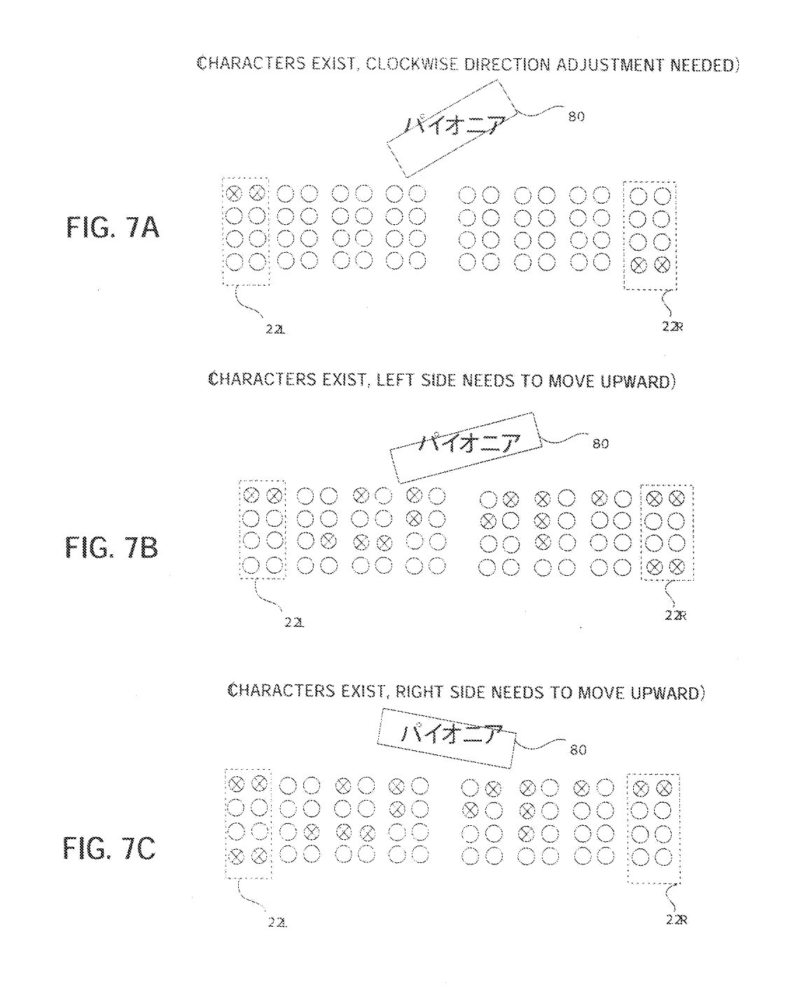

FIG. 7A shows a state of the movable pins 21 in the case where the movable pins 21 cannot display Braille because the horizontal axis direction of the captured image deviates from the lateral direction of the target characters for Braille by the angle Θth or greater in the counterclockwise direction. In this case, among all the movable pins 21, the display control unit 103 lifts up the two secondary pins in the first row of the single Braille display unit 22L, and also lifts up the two secondary pins in the fourth row of the single Braille display unit 22R. Namely, by lifting up the secondary pins on the upside of the single Braille display unit 22L, the display control unit 103 indicates that the left side of the handheld Braille converting device 1 needs to be moved upward, and by lifting up the secondary pins on the downside of the single Braille display unit 22R, the display control unit 103 indicates that the right side of the handheld Braille converting device 1 needs to move downward. Thereby, the display control unit 103 instructs the user operation so that the moving direction of the handheld Braille converting device 1 is rotated in the clockwise direction to coincide with the character string. In response, the user moves the left side of the handheld Braille converting device 1 upward and moves the right side of the handheld Braille converting device 1 downward thereby to correct the moving direction of the handheld Braille converting device 1 to the clockwise direction.

8. Target Character(s) for Braille Exists and Left Side of Device Needs to be Moved Upward

FIG. 7B shows a state of the movable pins 21 in the case where the left side of the handheld Braille converting device 1 needs to be moved upward because the horizontal axis direction of the captured image deviates from the lateral direction of the target characters for Braille within the angle Θth in the counterclockwise direction. Here, it is assumed that the character recognition unit 101 correctly recognizes all the target characters for Braille.

In this case, the display control unit 103 displays Braille of the target characters for the Braille by the primary pins on the single Braille display units 22A to 22F. Additionally, the display control unit 103 lifts up the two secondary pins in the first row among the secondary pins on the single Braille display unit 22L, and also lifts up the four secondary pins in the first and fourth row among the secondary pins on the single Braille display unit 22R. In other words, by lifting up the secondary pins on the upside of the single Braille display unit 22L, the display control unit 103 indicates that the left side of the handheld Braille converting device 1 needs to be adjusted upward. In contrast, by lifting up the secondary pins on the upside and the downside of the single Braille display unit 22R, the display control unit 103 indicates that the right side of the handheld Braille converting device 1 does not need to be adjusted. Thereby, the display control unit 103 instructs the user operation so that the handheld Braille converting device 1 is moved to coincide with the character string. In response, the user adjusts the left side of the handheld Braille converting device 1 upward.

9. Target Character(s) for Braille Exists and Right Side of Device Needs to be Moved Upward

FIG. 7C shows a state of the movable pins 21 in the case where the right side of the handheld Braille converting device 1 needs to be moved upward because the horizontal axis direction of the captured image deviates from the lateral direction of the target characters for Braille within the angle Θth in the clockwise direction. Here, it is assumed that the character recognition unit 101 correctly recognizes all the target characters for Braille.

The display control unit 103 displays Braille of the target characters for the Braille by the primary pins on the single Braille display units 22A to 22F. Additionally, the display control unit 103 lifts up the four secondary pins in the first and the fourth rows among the secondary pins on the single Braille display unit 22L, and also lifts up the two secondary pins in the first row among the secondary pins on the single Braille display unit 22R. In other words, by lifting up the secondary pins on the upside of the single Braille display unit 22R, the display control unit 103 indicates that the right side of the handheld Braille converting device 1 needs to be adjusted upward. In contrast, by lifting up the secondary pins on the upside and the downside of the single Braille display unit 22L, the display control unit 103 indicates that the left side of the handheld Braille converting device 1 does not need to be adjusted. Thereby, the display control unit 103 instructs the user operation so that the handheld Braille converting device 1 is moved to coincide with the character string. In response, the user adjusts the right side of the handheld Braille converting device 1 upward.

10. Target Character(s) for Braille Exists and Left Side of Device Needs to be Moved Downward

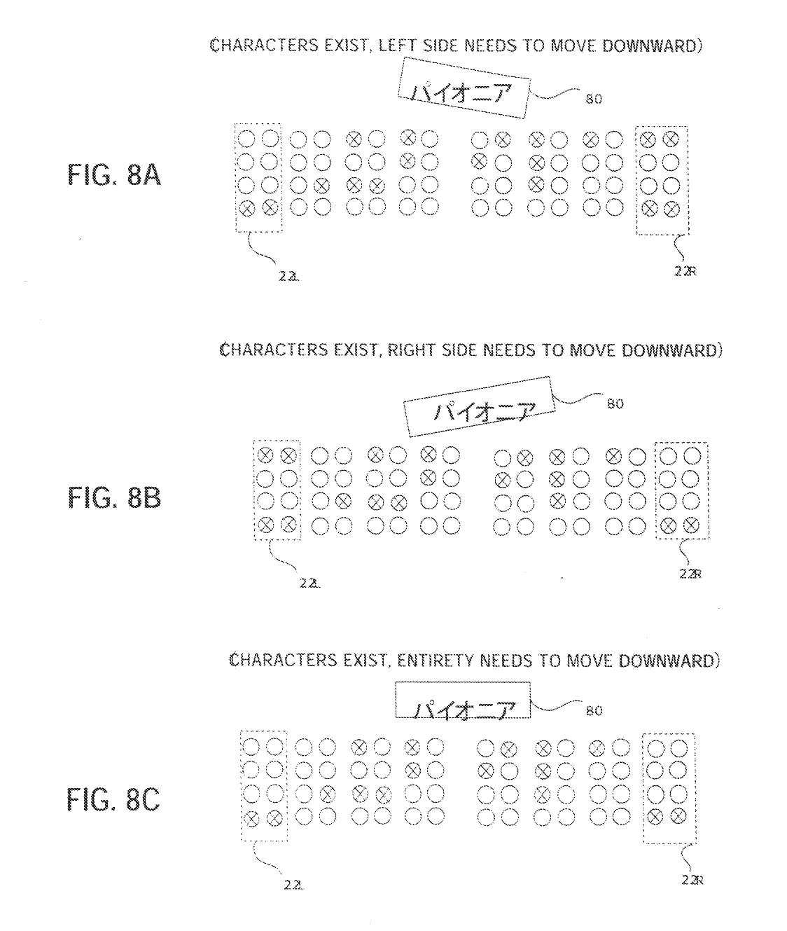

FIG. 8A shows a state of the movable pins 21 in the case where the left side of the handheld Braille converting device 1 needs to be moved downward because the horizontal axis direction of the captured image deviates from the lateral direction of the target characters for Braille within the angle Θth in the clockwise direction. Here, it is assumed that the character recognition unit 101 correctly recognizes all the target characters for Braille.

In this case, the display control unit 103 displays Braille of the target characters for the Braille by the primary pins on the single Braille display units 22A to 22F. Additionally, the display control unit 103 lifts up the two secondary pins in the fourth row among the secondary pins on the single Braille display unit 22L, and also lifts up the four secondary pins in the first and fourth rows among the secondary pins on the single Braille display unit 22R. In other words, by lifting up the secondary pins on the downside of the single Braille display unit 22L, the display control unit 103 indicates that the left side of the handheld

Braille converting device 1 needs to be adjusted downward. In contrast, by lifting up the secondary pins on the upside and the downside of the single Braille display unit 22R, the display control unit 103 indicates that the right side of the handheld Braille converting device 1 does not need to be adjusted. Thereby, the display control unit 103 instructs the user operation so that the handheld Braille converting device 1 is moved to coincide with the character string. In response, the user adjusts the left side of the handheld Braille converting device downward.

11. Target Character(s) for Braille Exists and Right Side of Device Need to Be Moved Downward

FIG. 8B shows a state of the movable pins 21 in the case where the right side of the handheld Braille converting device 1 needs to be moved downward because the horizontal axis direction of the captured image deviates from the lateral direction of the target characters for Braille within the angle Θth in the counterclockwise direction. Here, it is assumed that the character recognition unit 101 correctly recognizes all the target characters for Braille.

In this case, the display control unit 103 displays Braille of the target characters for the Braille by the primary pins on the single Braille display units 22A to 22F. Additionally, the display control unit 103 lifts up the two secondary pins in the first and the fourth rows among the secondary pins on the single Braille display unit 22L, and also lifts up the two secondary pins in the fourth row among the secondary pins on the single Braille display unit 22R. In other words, by lifting up the secondary pins on the downside of the single Braille display unit 22R, the display control unit 103 indicates that the right side of the handheld Braille converting device 1 needs to be adjusted downward. In contrast, by lifting up the secondary pins on the upside and the downside of the single Braille display unit 22L, the display control unit 103 indicates that the left side of the handheld Braille converting device 1 does not need to be adjusted. Thereby, the display control unit 103 instructs the user operation so that the handheld Braille converting device 1 is moved to coincide with the character string. In response, the user adjusts the right side of the handheld Braille converting device 1 downward.

12. Target Character(s) for Braille Exists and Entire Device Needs to be Moved Downward

FIG. 8C shows a state of the movable pins 21 in the case where the handheld Braille converting device 1 in its entirety deviates upward from the target characters for Braille within a range where the characters can be recognized. Here, it is assumed that the character recognition unit 101 correctly recognizes all the target characters for Braille.

In this case, the display control unit 103 displays Braille of the target characters for the Braille by the primary pins on the single Braille display units 22A to 22F. Additionally, the display control unit 103 lifts up the two secondary pins in the fourth row among the secondary pins on the single Braille display unit 22L, and also lifts up the two secondary pins in the fourth row among the secondary pins on the single Braille display unit 22R. In other words, by lifting up the secondary pins on the downsides of the single Braille display units 22R and 22L, the display control unit 103 indicates that the handheld Braille converting device 1 in its entirety needs to be adjusted downward. Thereby, the display control unit 103 instructs the user operation so that the handheld Braille converting device 1 is moved to coincide with the character string. In response, the user adjusts the handheld Braille converting device 1 in its entirety downward.

13. Target character(s) for Braille Exists and Entire Device Needs to be Move Upward

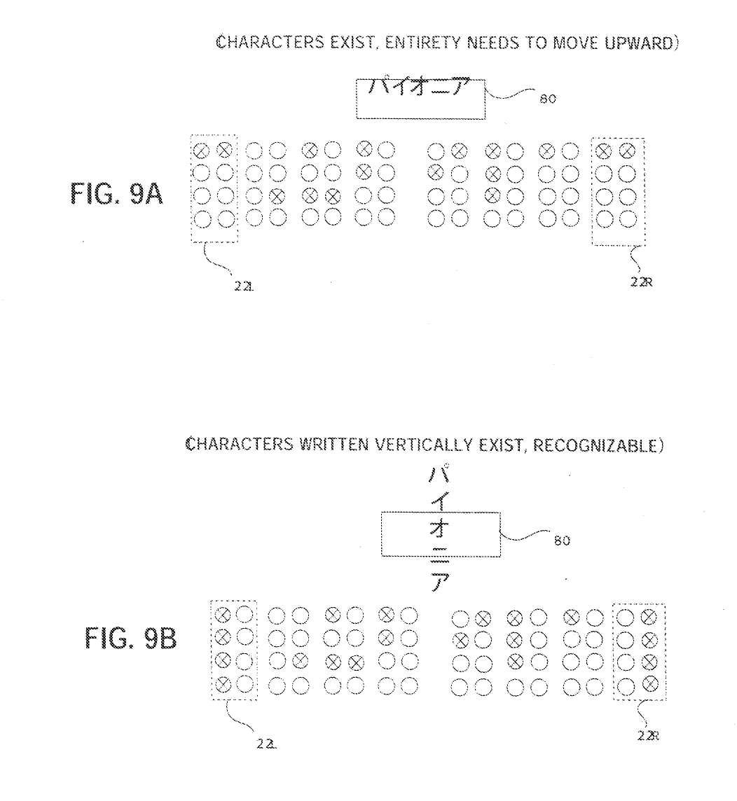

FIG. 9A shows a state of the movable pins 21 in the case where the handheld Braille converting device 1 in its entirety deviates downward from the target characters for Braille within a range where the characters can be recognized. Here, it is assumed that the character recognition unit 101 correctly recognizes all the target characters for Braille.

In this case, the display control unit 103 displays Braille of the target characters for the Braille by the primary pins on the single Braille display units 22A to 22F. Additionally, the display control unit 103 lifts up the two secondary pins in the first row among the secondary pins on the single Braille display unit 22L, and also lifts up the two secondary pins in the first row among the secondary pins on the single Braille display unit 22R. In other words, by lifting up the secondary pins on the upsides of the single Braille display units 22R and 22L, the display control unit 103 indicates that the handheld Braille converting device 1 in its entirety needs to be adjusted upward. Thereby, the display control unit 103 instructs the user operation so that the handheld Braille converting device 1 is moved to coincide with the character string. In response, the user adjusts the handheld Braille converting device 1 in its entirety upward.

14. Target Character(s) for Braille Written Vertically Exists and Recognizable

FIG. 9B shows a state of the movable pins 21 in the case where the target characters for Braille are written vertically and where the character recognition unit 101 correctly recognizes all the target characters for Braille.

In this case, the display control unit 103 displays Braille of the target characters for the Braille by the primary pins on the single Braille display units 22A to 22F. Additionally, the display control unit 103 lifts up the four secondary pins in the first column among the secondary pins on the single Braille display unit 22L, and also lifts up the four secondary pins in the second column among the secondary pins on the single Braille display unit 22R. In other words, when the target character(s) for Braille is written vertically, the display control unit 103 lifts up the secondary pins arranged in the vertical direction. Thereby, the display control unit 103 instructs the user operation so that the handheld Braille converting device 1 is moved to coincide with the character string.

When the target characters for Braille are written vertically and one of the above 1 to 13 patterns is applicable, the display control unit 103 lifts up the secondary pin in the first row and the first column and the secondary pin in the second row and the first column, instead of the two secondary pins in the first row on the single Braille display unit 22L, and also lifts up the secondary pin in the third row and the first column and the secondary pin in the fourth row and the first column, instead of the two secondary pins in the fourth row on the single Braille display unit 22L. In addition, the display control unit 103 lifts up the secondary pin in the first row and second column and the secondary pin in the second row and second column, instead of the two secondary pins in the first row on the single Braille display unit 22R, and also lifts up the secondary pin in the third row and the second column and the secondary pin in the fourth row and the second column, instead of the two secondary pins in the fourth row on the single Braille display unit 22R. Thereby, it is possible to instruct the user operation according to the vertical writing and also to prompt the correction of the moving direction of the handheld Braille converting device 1.

15. Guide Direction of Initial Character

Next, a description will be given of the control of the movable pins 21 at the time when the handheld Braille converting device 1 is put on a document and when the Braille processing starts automatically or based on the user instruction and when the direction of the character (hereinafter referred to as “initial character”) to be read first in a document is guided. Here, the expression “document” indicates a target document to be read and other medium for communication on which characters are described.

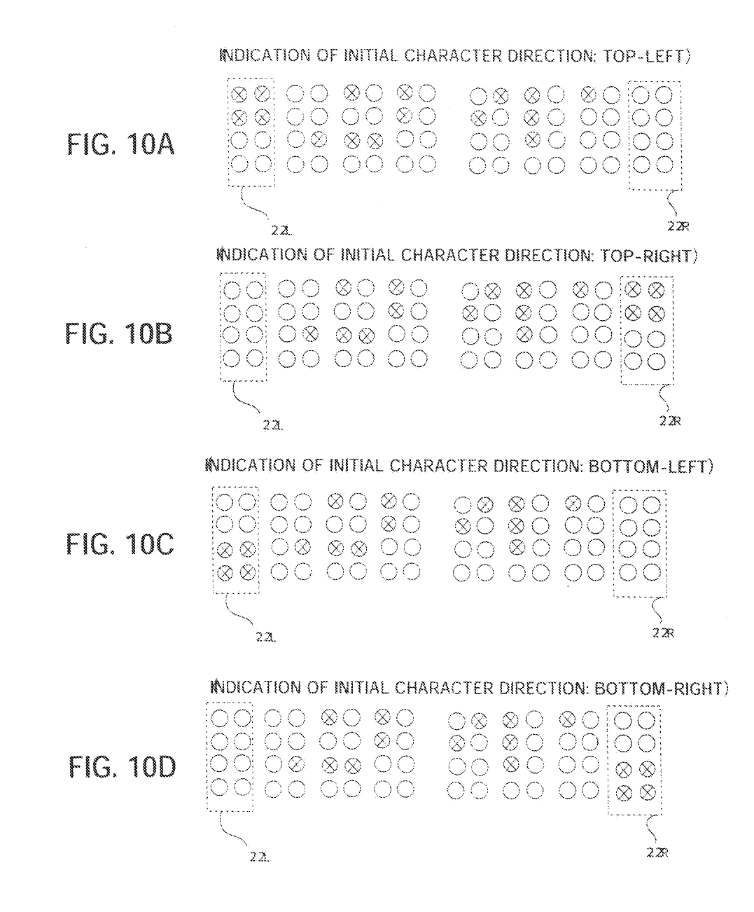

FIG. 10A shows a state of the movable pins 21 in the case where the initial character exists in the top-left direction. FIG. 10B shows a state of the movable pins 21 in the case where the initial character exists in the top-right direction. FIG. 10C shows a state of the movable pins 21 in the case where the initial character exists in the bottom-left direction. FIG. 10D shows a state of the movable pins 21 in the case where the initial character exists in the bottom-right direction. Here, each state of the single Braille display units 22A to 22F shown in FIGS. 10A to 10D is only an example and is not directly related to the guide of the direction of the initial character.

In this case, the display control unit 103 lifts up the secondary pins existing in the direction where the moving direction is to be corrected, for user's finger placed on the handheld Braille converting device 1, and lowers the secondary pins existing in the other directions. Concretely, when the initial character exists in the top-left direction, the display control unit 103 lifts up the four secondary pins in the first row and the second row on the single Braille display unit 22L among the secondary pins on the single Braille display units 22L and 22R as shown in FIG. 10A. When the initial character exists in the top-right direction, the display control unit 103 lifts up the four secondary pins in the first row and the second row on the single Braille display unit 22R among the secondary pins on the single Braille display units 22L and 22R as shown in FIG. 10B. When the initial character exists in the bottom-left direction, the display control unit 103 lifts up the four secondary pins in the third row and the fourth row on the single Braille display unit 22L among the secondary pins on the single Braille display units 22L and 22R as shown in FIG. 10C. When the initial character exists in the bottom-right direction, the display control unit 103 lifts up the four secondary pins in the third row and the fourth row on the single Braille display unit 22R among the secondary pins on the single Braille display units 22L and 22R as shown in FIG. 10D.

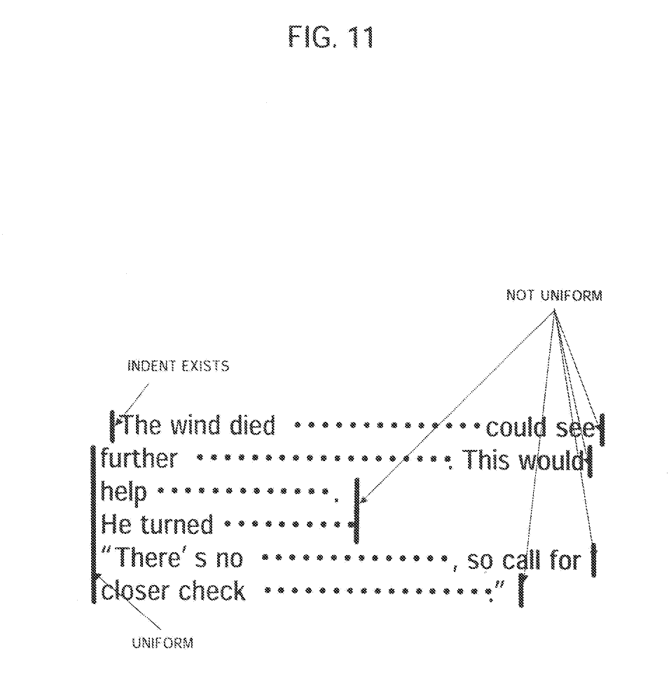

Next, a description will be given of a concrete method by which the character recognition unit 101 specifies the initial character from the captured image. For example, when the handheld Braille converting device 1 specifies the initial character, it obtains the captured image showing the whole set of the character string (“hereinafter simply referred to as “entirety of the document”) described in the document from the camera 15, and estimates the initial character in the captured image. This description will be given with reference to FIG. 11. FIG. 11 shows an example of the captured image showing the entirety of the document. First, the character recognition unit 101 specifies the range where each character string in the entirety of the document is described. For example, at first, the character recognition unit 101 specifies the boundary of the width of each character string in the document as shown by the vertical lines in FIG. 11. Next, the character recognition unit 101 recognizes the fact that only the boundary of the first row deviates among the boundaries at the left side of each character string by the indention and that the boundaries of the rows following the first row are uniform or exist on approximately the same straight line within a predetermined difference, and the fact that the boundaries at the right side of each character string are not uniform. The above-mentioned predetermined difference is set to a value smaller than a space equivalent corresponding to an indentation, for example. Then, the character recognition unit 101 determines that the leftmost character in the first row is the initial character in consideration of the above two facts. After that, the display control unit 103 guides the user operation as shown in FIG. 10A so that the handheld Braille converting device 1 is moved toward the top-left.

In another example instead of the example shown in FIG. 11, when the handheld Braille converting device 1 is put on the document firsthand, there is a possibility that the angle Θr of each character string in the entirety of the document is 180°, which indicates upside down, and/or that the absolute value of the angle Θr is equal to or larger than the angle Θth. In this case, the display control unit 103 controls the secondary pins according to the above-mentioned sixth concrete example shown in FIG. 6C and the seventh concrete example shown in FIG. 7A, if necessary. Thereby, the display control unit 103 guides the user operation to coincide each character string with the horizontal axis of the captured image.

Next, a description will be given of conditions for terminating the guide of the initial character direction. For example, the display control unit 103 terminates the guide of the initial character direction if one of the following conditions (a) to (e) or any combination of them is met.

(a) A condition that there is no character in the captured image, i.e., a condition that the state has transited to the state of the first concrete example shown in FIG. 5A.

(b) A condition that it has reached the boundary at the right side of the character string, i.e., a condition that the state has transited to the state of the fourth concrete example shown in FIG. 6A.

(c) A condition that it has reached the boundary at the left side of the character string, i.e., a condition that the state has transited to the state of the fifth concrete example shown in FIG. 6B.

(d) A condition that it has reached the upper boundary of the character string in the first row of the document, i.e., a condition that the state has transited from the state of the twelfth concrete example shown in FIG. 8C to the state of the first example shown in FIG. 5A.

(e) A condition that it has reached the bottom boundary of the character string in the last row of the document, i.e., a condition that the state has transited from the state of the thirteenth concrete example shown in FIG. 9A to the state of the first example shown in FIG. 5A.

As described above, the handheld Braille converting device 1 can properly guide the user operation by using the secondary pins in various cases.

[Character Recognition Method and Braille Converting Method]

Next, the character recognition method and the Braille converting method will be described below. Summarily, the character recognition unit 101 calculates an average character width (hereinafter simply referred to as “average character width Wr”) of each character, which constitutes the target character string to be read, based on the character string length Lr of the character string to be read and the number (hereinafter referred to as “character number Nr”) of the characters. Next, the Braille converting unit 102 calculates the number (hereinafter referred to as “Braille cell number Ns”) of the single Braille display units 22 necessary for displaying Braille when the character string is converted into the Braille equivalent. When the handheld Braille converting device 1 moves, the display control unit 103 displays the Braille of the character string at an average interval on the basis of the average character width Wr and the Braille cell number Ns.

First, with reference to FIG. 12, a description will be given of the process executed by the handheld Braille converting device 1 when the handheld Braille converting device 1 is put on the document for the sake of the Braille display. FIG. 12 shows an example of the captured image obtained from the camera 15. The captured image 50 shown in FIG. 12 consists of multiple pieces of character string horizontally written. Hereinafter, a relative position on the captured image 50 is expressed as “(x, y)” by the two dimensional coordinates defining a position (referred to as “x-coordinate”) on the horizontal axis and a position (referred to as “y-coordinate”) on the vertical axis where the top-left corner is the origin. Here, “x” indicates a value (0≦x≦1000) of the x-coordinate and “y” indicates a value (0≦y≦1000) of the y-coordinate. The lateral broken line in FIG. 12 shows the position of the center of the y-coordinate, i.e., the position “y=500”, and the vertical broken line indicates the position of the center of the x-coordinate, i.e., the position “x=500”. It is noted that the boundary of each character string 70 in the captured image 50 is expressed by the broken-line frame or the solid-line frame for convenience of explanation.

First, the character recognition unit 101 recognizes multiple pieces of the character string 70 shown in the broken-line frame from the captured image 50. Then, the character recognition unit 101 calculates the position Pr, the angle Θr and the character string length Lr with respect to each piece of the character string 70. Here, the character recognition unit 101 obtains a pair of the coordinate at the top-left corner and the coordinate at the bottom-right corner with respect to each piece of character string 70 as the position Pr of the character string 70. The character recognition unit 101 also calculates the absolute value of the difference between the x-coordinate of the left-side boundary and the y-coordinate of the right-side boundary with respect to each piece of the character string 70 as the character string length Lr.

Next, the character recognition unit 101 specifies the character string 70 including the central coordinate (500, 500) located at the center of the captured image 50 or the character string 70 closest to the central coordinate among the multiple piece of the recognized character string 70 as the target character string for Braille. Here, the character recognition unit 101 specifies the character string 70x in the solid-line frame including the central coordinate as the target character string for Braille, based on each position Pr of the character string 70. Namely, the character string 70y in the broken-line frame is not the target character string for Braille.

Next, the Braille converting unit 102 counts up the character number Nr of the character string 70x which is the target character string for Braille, and sets the average character width Wr to the value which is obtained by dividing the character string length Lr of the character string 70x by the character number Nr. Namely, the Braille converting unit 102 calculates the average character width Wr by using the following equation (1).

Wr=Lr/Nr (1)

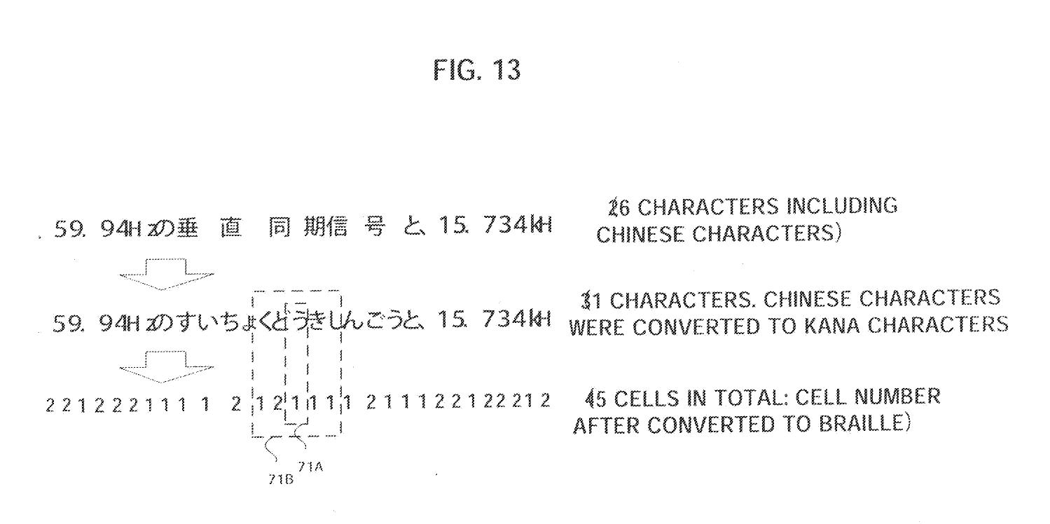

Then, the Braille converting unit 102 calculates the Braille cell number Ns of the character string 70x after converting each character of the character string 70x to Braille. This processing will be explained with reference to FIG. 13. FIG. 13 is a conceptual diagram showing the processing for calculating the Braille cell number Ns with respect to the character string 70x.

The first row in FIG. 13 is the character string 70x itself shown in the captured image 50. The character string in the first row contains 26 characters including the Chinese characters. Namely, the character number Nr is 26. The second row in FIG. 13 shows the character string after the conversion (kana conversion) of the Chinese characters in the character string 70x to the kana characters. The second row contains the 31 characters.

In the third row in FIG. 13, there are arranged numbers (Braille cell numbers) of the single Braille display units 22 necessary for displaying Braille of each character in the second row in FIG. 13. Here, the Braille cell number is two in case of a kana character, which includes a numeric character and a character with a voiced sound mark, and an alphabet in capital letters, and the Braille cell number is one in case of other characters. By calculating the sum of the Braille cell number of each character as shown in the third row, the Braille converting unit 102 specifies that the Braille cell number Ns necessary for displaying the Braille of the character string 70x is 45.

After calculating the Braille cell number Ns of the character string 70x, the Braille converting unit 102 specifies the character (hereinafter referred to as “central character”) located at the center of the character string 70x which is the target character string for Braille. Concretely, the Braille converting unit 102 specifies the character in the character string 70x closest to the coordinates (500, 500) positioned at the center of the captured image, i.e., the intersection of the broken lines shown in FIG. 12, as the central character. Namely, the Braille converting unit 102 specifies the character “ [symbol] ” in the broken-line flame 71 shown in FIG. 13 as the central character.

Then, the display control unit 103 displays Braille of characters capable of being converted to Braille, which include the central character, by the six cells of the single Braille display units 22A to 22F. Concretely, the display control unit 103 displays Braille of the characters “ [symbol] ” equivalent to six cells shown in the broken-line frame 71B in FIG. 13 by the single Braille display units 22A to 22F.

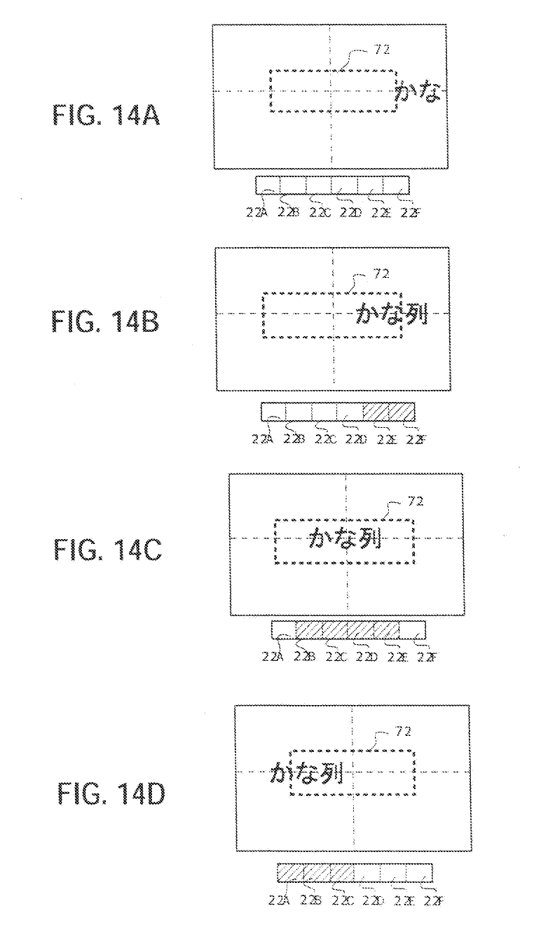

It is noted that the display control unit 103 determines the target character string for Braille by the method different from the above-mentioned method if the target character string for Braille is not displayed all over the captured image 50 in its width. This will be described with reference to FIGS. 14A to 14D.

FIGS. 14A to 14D show the position of the target character string for Braille consisting of the character string “ [symbol] ” and the single Braille display units 22A to 22F to be used. The handheld Braille converting device 1 is gradually moving toward the right direction from FIGS. 14A through 14D. Here, it is assumed that the Braille cell number of “ [symbol] ” corresponding to the kana characters of “ [symbol] ” is one per character. The broken-line frame 72 shows the existence range (hereinafter “target range for Braille”) of the target characters for Braille.

First, in FIG. 14A, a part of the target character string for Braille is displayed in the right edge of the captured image. In this case, the display control unit 103 determines that the target character string for Braille does not exist in the target range for Braille shown in the broken-line frame 72, and does not display the Braille on the single Braille display units 22A to 22F.

Next, in FIG. 14B, the characters [symbol] of the target character string for Braille exist in the target range for Braille. In this case, based on the relative position of the character string [symbol] in the target range for Braille, the display control unit 103 displays Braille of the character [symbol] of the characters

[symbol]

[symbol]

obtained by the kana conversion of the characters [symbol] on the single Braille display unit 22E, and also displays Braille of the [symbol] on the single Braille display unit 22F. It is only necessary to display Braille of just the first character on the single Braille display units 22E and 22F if the target character string for the Braille existing in the target range for the Braille includes a character (for example, character with voiced sound mark), whose kana character needs two single Braille display units for displaying Braille.

In FIG. 14C, the target character string for Braille in its entirety exists in the target range for the Braille. In this case, based on the relative position 72 of each character of the character string [symbol] in the target range for Braille, the display control unit 103 displays Braille of the character

[symbol]

of the characters string [symbol]
obtained by the kana conversion of the character string [symbol]
on the single Braille display unit 22B, and also displays Braille of the character [symbol]
on the single Braille display unit 22C. Additionally, the display control unit 103 displays the Braille of the character [symbol]
on the single Braille display unit 22D and also displays the Braille of the character [symbol]
on the single Braille display unit 22E.

Finally, in FIG. 14D, the part

[symbol]

of the target character string for Braille exists in the target range for the Braille. In this case, based on the relative position of each character of the character string [symbol]
in the target range for Braille, the display control unit 103 displays the Braille of the character [symbol]
of the character string [symbol]
obtained by the kana conversion of the character string [symbol]
on the single Braille display unit 22A. Additionally, the display control unit 103 displays the Braille of the character [symbol]
on the single Braille display unit 22B and also displays the Braille of the character [symbol]
on the single Braille display unit 22C. It is noted the display control unit 103 displays the Braille of just the second character on the single Braille display unit 22A if the target character string for Braille existing in the target range for the Braille includes a character, whose kana character needs two single Braille display units for displaying Braille.

As described above, the display control unit 103 displays

Braille of only the character(s) existing in the target range for the Braille when the target character string for the Braille does not exist in all over the captured image in its width. In addition, the display control unit 103 changes the single Braille display units 22, which display Braille of the character, based on the relative position of the character in the target range for Braille.

Next, a description will be given of the processing at the time when the position of the handheld Braille converting device 1 has moved. In this case, the character recognition unit 101 obtains the captured image from the camera 15 at a constant time interval and specifies the target character string for Braille by executing the above-mentioned processing. Then, the character recognition unit 101 determines whether or not the specified target character string for Braille coincides with the target character string for Braille having been specified last time.

When the above target character string for Braille does not coincide, the character recognition unit 101 executes the above-mentioned processing all over again. Namely, the character recognition unit 101 specifies new character string in the captured image to start the processing of obtaining the information of the position Pr. In the case where the target character string for Braille is displayed all over the captured image 50 in its width, the target character string for Braille is partially changed even if it moves only by one character length. Therefore, in this case, the character recognition unit 101 determines that the target character string for Braille is changed.

In contrast, if the two target character string for Braille coincides, the Braille converting unit 102 calculates the deviation (hereinafter referred to as “shift width”) between the position Pr (hereinafter referred to as “position Pr1”) of the target character string for Braille in the previous captured image and the position Pr (hereinafter referred to as “position Pr2”) of the target character string for Braille in the new captured image. The expression “previous captured image” herein indicates the captured image corresponding to the current Braille display. Then, the Braille converting unit 102 shifts the Braille display based on the average character width Wr and the Braille cell number Ns according to the shift width.

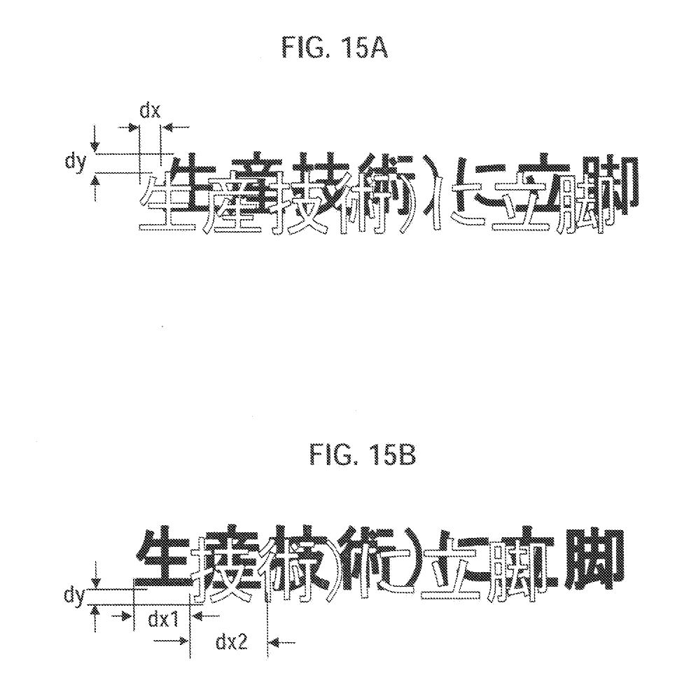

The processing will be explained with reference to FIG. 15A. FIG. 15A is one example of a diagram showing the relative position of the character string before and after the movement. Here, the character string before the movement is illustrated by the outline characters, and the character string after the movement is illustrated by the thick characters. In FIG. 15A, the symbol “dx” stands for the shift width in the horizontal axis direction, the symbol “dy” stands for the shift width in the vertical axis direction.

First, the Braille converting unit 102 calculates the shift width dx and the shift width dy based on the position Pr1 and the position Pr2. Then, the Braille converting unit 102 compares the shift width dx to a value (hereinafter referred to as “average cell width Ws”) obtained by multiplying the average character width Wr by the value (Nr/Ns), which is obtained by dividing the character number Nr by the Braille cell number Ns. Namely, the average cell width Ws meets the following equation (2).

Ws=Wr^{x}Nr/Ns (2)

When the Braille converting unit 102 determines that the shift width dx is equal to or larger than the average cell width Ws or is within a predetermined difference from the average cell width Ws, the display control unit 103 shifts the Braille display by one single Braille display unit 22 equivalent in the shift direction (in FIG. 15A, right direction) of the character string. The above-mentioned “predetermined difference” is determined by experimental trials, for example. Namely, for example, when the display control unit 103 shifts the Braille display by one single Braille display unit 22 in the right direction, the display control unit 103 displays the Braille, which has been displayed on the single Braille display units 22A to 22E, on the single Braille display units 22B to 22F instead, and displays Braille of a new character on the single Braille display unit 22A. Thereby, display control unit 103 can display the Braille of the target character string for Braille at an average interval. In addition, when the shift width dy is equal to or larger than a predetermined value, the display control unit 103 guides the user operation by the secondary pins as shown in FIG. 8C or FIG. 9A, for example. In contrast, when the shift width dx is smaller than the average cell width Ws, the Braille display does not vary (does not shift). Instead, the above-mentioned shift width dx is added to the shift width dx used next time so that the shift width dx used next time becomes the shift width from the last time when the Braille display is shifted.

A description will be given of the case where the target character string for Braille is changed because the target character string for Braille moves by one character equivalent or larger with reference to FIG. 15B. In this case, the character recognition unit 101 searches the partially-matched character string between the target character string for Braille before and after the movememt, and shifts the Braille based on the moving distance of the partially-matched character string. This will be described below with reference to FIG. 15B. FIG. 15B is one example showing the relative position of the target character string for Braille before and after the movememt. Here, similarly to FIG. 15A, the character string before the movememt is illustrated by the outline characters, and the character string after the movememt is illustrated by the thick characters. In FIG. 15B, the symbol “dx1” stands for the shift width of the front edge character of the target character string for Braille before and after the movememt in the horizontal axis direction, the symbol “dx2” stands for the shift width of the partially-matched character string

[symbol]

in the horizontal axis direction, and the symbol “dy” stands for the shift width in the vertical direction.

First, the character recognition unit 101 calculates each of the shift widths dxl, dx2 and dy. Then, the Braille converting unit 102 calculates the value (dx2/Ws) which is the shift width dx2 divided by the average cell width Ws. After that, the display control unit 103 redisplays Braille by shifting the Braille display by the number of the single Braille display units 22 corresponding to the above value (dx2/Ws) in the shift direction (In FIG. 15B, right direction). Thereby, even in this case, the display control unit 103 can display Braille of the target character string for the Braille at an average interval. If the above value (dx2/Ws) includes a decimal fraction, the Braille converting unit 102 may raise the decimal fraction to the integer by rounding off or another way. In addition to the above-mentioned processing, the display control unit 103 guides the user operation by the secondary pins as shown in FIG. 8C or FIG. 9A when the shift width dy is equal to or larger than a predetermined value. The above-mentioned “predetermined value” is set in advance by experimental trials. The display control unit 103 also recognizes the position of character(s), whose Braille is currently being displayed, in the target character string for Braille, and executes the relative position correctness indication display as shown in FIG. 6B, for example.

In contrast, when there is no partially-matched character string in the target character string for Braille before and after the movement, the character recognition unit 101 re-executes all the processes from the process specifying the target character string for Braille.

[Process Flow]

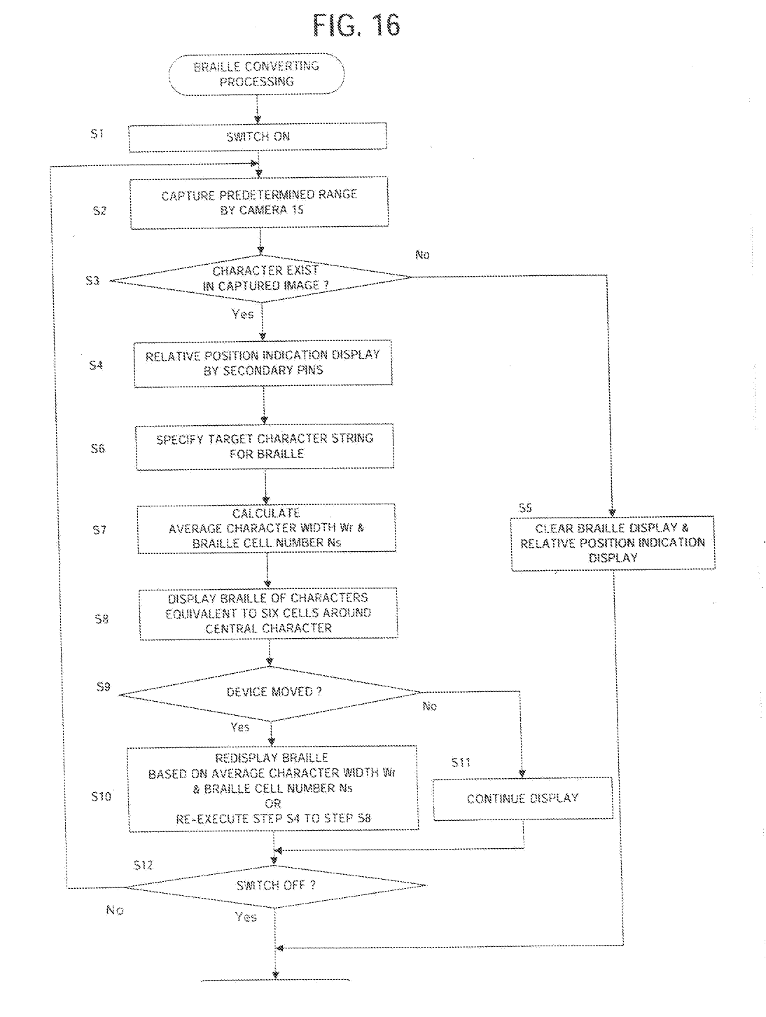

Next, a description will be given of the Braille converting processing according to the embodiment with reference to FIG. 16. This processing is performed by the execution of the program prepared in advance by the system controller 19 shown in FIG. 1. FIG. 16 is a flowchart of the Braille converting processing.

The user puts the handheld Braille converting device 1 on the printed matter on which there are characters to be displayed as Braille, and turns on the switch of the Braille converting processing (step S1). The camera 15 captures a predetermined range around the handheld Braille converting device 1 (step S2), and transmits the captured image to the character recognition unit 101.

Next, the character recognition unit 101 determines whether or not any character exists in the captured image received (step S3). When some characters exist in the captured image (step S3; Yes), the display control unit 103 displays the relative position correctness indication display (step S4). For example, the display control unit 103 informs the user of the initial character direction by the relative position correctness indication display shown in FIG. 10. In another example, if the character string is written vertically, the display control unit 103 displays the relative position correctness indication display shown in FIG. 9B thereby to inform the user that the character string is written vertically. Additionally, if the character string is shifted, the display control unit 103 displays the relative position correctness indication display as shown in FIG. 6C thereby to inform the user in which direction the handheld Braille converting device 1 is shifted.

When any character does not exist in the captured image (step S3; No), the display control unit 103 clears all the Braille display and the relative position correctness indication display (step S5). In other words, the display control unit 103 controls the primary pins and the secondary pins to be in the state shown in FIG. 5A.

Next, after executing step S5, the character recognition unit 101 specifies the target character string for Braille (step S6). Concretely, the character recognition unit 101 specifies the character string existing in the center of the captured image from all character string in the captured image as the target character string for Braille.

Then, the Braille converting unit 102 calculates the average character width Wr and the Braille cell number Ns of the target character string for Braille (step S7). Concretely, the Braille converting unit 102 calculates the average character width Wr based on the equation (1). Additionally, the Braille converting unit 102 calculates the Braille cell number Ns to be needed after converting Chinese character(s) of the target character string for Braille to kana character(s) as shown in FIG. 13.

Next, the display control unit 103 displays Braille of characters equivalent to six cells around the central character (step S8). Here, as described above, the central character indicates the character closest to the center of the captured image in the target character string for Braille.

Next, the character recognition unit 101 determines whether or not the device has moved based on the variation of the captured images (step S9). When the device has moved (step S9; Yes), the display control unit 103 executes the process at step S10. Concretely, when the target character string for Braille before and after the movememt completely or partially coincides, the Braille converting unit 102 calculates the shift width on the horizontal axis and calculates the average cell width Ws based on the average character width Wr and the Braille cell number Ns as shown in the equation (2). Then, the display control unit 103 redisplays the Braille by specifying the number of the single Braille display units 22 to be shifted on the basis of the shift width and the average cell width Ws. Thereby the display control unit 103 can display the Braille of the target character string for Braille at an average interval. In contrast, the handheld Braille converting device 1 re-executes the processes at steps S4 to S8 when it cannot find a correspondent part of the target character string for Braille before and after the movement.

In contrast, when the device has not moved (step S9; No), the display control unit 103 continues the display (step S11).

Next, the handheld Braille converting device 1 determines whether or not the switch is turned off (step S12). When the switch is not turned off (step S12; No), the process goes back to step S2 to repeat steps S2 to S11. When the switch is turned off (step S12; Yes), the process ends.

[Modification]

Next, modifications of the embodiment will be described below. Following modifications can be applied to the above-mentioned embodiment in combination with each other.

In addition to the above explanation, the display control unit 103 may quickly vibrate the second pins up and down when lifting up the second pins. Thereby, the display control unit 103 can prevent the user from confusing the Braille display by the first pins with the relative position correctness indication display by the second pins.

Although each of the primary Braille module 10x and the secondary Braille module 10y has four single Braille display units 22 in the above-mentioned embodiment, the present invention is not limited to that configuration. Concretely, the number of the single Braille display units 22 may be determined to the number that the user can recognize with their fingertips most easily. Even in this case, the display control unit 103 uses any two single Braille display units 22 as the second pins. Additionally, not only the configuration that one single Braille display unit 22 is equipped with eight movable pins 21 having two columns and four rows, but also a configuration that the one single Braille display unit 22 is equipped with six movable pins 21 having two columns and three rows may be applied to the present invention, for example.

Although characters in the printed matter are converted to Braille in the above-described embodiment, the present invention is not limited to this. Other than printed characters, any characters that can be captured by the CCD camera can be converted to Braille.

In the section “Control of Moving Second Pins”, the display control unit 103 lifts up the secondary pins existing in the direction where the moving direction is supposed to be changed, and lowers the secondary pins existing in the other directions, for the fingers which the user puts on the handheld Braille converting device 1, in principle. However, the method to which the present invention can be applied is not limited to the method. Instead, the display control unit 103 may make the second pins function as the barricade. In other words, in principle, the display control unit 103 may lower the secondary pins existing in the direction where the moving direction is supposed to be changed, and lift up the secondary pins existing in the other directions, for the fingers which the user puts on the handheld Braille converting device 1. Thereby the handheld Braille converting device 1 can properly guide the user operation as well. In another example, the display control unit 103 may vibrate the first pins and the second pins instead of lifting up and lowering these pins.

### BRIEF DESCRIPTION OF REFERENCE NUMBERS

1 Handheld Braille Converting Device

10 Braille display unit

11 CPU

14 Power supply

15 Camera

16 Lens

17 Lighting LED

19 System Controller

101 Character Recognition Unit

102 Braille Converting Unit

103 Display Control Unit

1. A handheld Braille converting device movable while being held by a user by a single hand, comprising:
a Braille display unit which is arranged at a position capable of being contacted by at least one finger of a hand of the user holding the device and which displays Braille;
an image capturing means which captures a predetermined range around the handheld Braille converting device;
a character recognition means which detects presence/absence of character(s) existing in an image captured by the image capturing means and recognizes the character(s);
a Braille converting means which converts a part of or all the characters recognized by the character recognition means to Braille; and
a display control means which displays the Braille converted by the Braille converting means on the Braille display unit,
wherein the Braille display unit includes multiple single Braille display units each corresponding to one Braille character;
wherein each single Braille display unit includes multiple movable members; and
wherein the display control means displays whether or not the relative position of the handheld Braille converting device is correct with respect to a character or character string existing in the captured image, by operating members included in a part of the single Braille display units, and displays Braille by operating members included in the other single Braille display units.

2. The handheld Braille converting device according to claim 1,
wherein the single Braille display units are arranged side by side; and
wherein the display control means displays whether or not the relative position of the handheld Braille converting device is correct with respect to a character or character string existing in the captured image, by operating members included in the single Braille display units positioned at both ends.

3. The handheld Braille converting device according to claim 1,
wherein the display control means indicates in which direction the position of the handheld Braille converting device is shifted with respect to the character or the character string existing in the captured image, by operating the members included in the part of the single Braille display units.

4. The handheld Braille converting device according to claim 1,
wherein the display control means indicates the presence/absence of character(s) in the captured image, by operating the members included in the part of the single Braille display units.

5. The handheld Braille converting device according to claim 1,
wherein the display control means indicates whether the character string existing in the captured image is written vertically or horizontally, by operating the members included in the part of the single Braille display units.

6. The handheld Braille converting device according to claim 1,
wherein the display control means indicates a direction of an initial character of the character string existing in the captured image, by operating the members included in the part of the single Braille display units.

7. The handheld Braille converting device according to claim 1,
wherein the display control means displays whether or not the relative position is correct by lifting up and lowering the members included in the part of the single Braille display units to form the convex shapes while vibrating the members, and displays Braille by lifting up and lowering the members included in the other part of the single Braille display units to form the convex shapes.

8. The handheld Braille converting device according to claim 1,
wherein the Braille converting means calculates an average character width of each character constituting character string to be displayed as Braille, and calculates the number of the Braille corresponding to the character string; and
wherein the display control means shifts a display of Braille based on the average character width and the number of the Braille when the handheld Braille converting device has moved.

9. A Braille converting method executed by a handheld Braille converting device movable while being held by a user by a single hand and including a Braille display unit which is arranged at a position capable of being contacted by at least one finger of a hand of the user holding the device and which displays Braille, the method comprising:
an image capturing process which captures a predetermined range around the handheld Braille converting device;
a character recognition process which detects presence/absence of character(s) existing in an image captured by the image capturing process and recognizes the character(s);
a Braille converting process which converts a part of or all the characters recognized by the character recognition process to Braille; and
a display control process which displays the Braille converted by the Braille converting process on the Braille display unit,
wherein the Braille display unit includes multiple single Braille display units each corresponding to one Braille character;
wherein each single Braille display unit includes multiple movable members; and
wherein the display control process displays whether or not the relative position of the handheld Braille converting device is correct with respect to a character or character string existing in the captured image, by operating members included in a part of the single Braille display units, and displays Braille by operating members included in the other single Braille display units.

10. A Braille converting program stored on a non-transitory storage medium and executed by a handheld Braille converting device movable while being held by a user by a single hand and including a Braille display unit which is arranged at a position capable of being contacted by at least one finger of a hand of the user holding the device and which displays Braille, the program making the Braille converting device function as:
an image capturing means which captures a predetermined range around the handheld Braille converting device;
a character recognition means which detects presence/absence of character(s) existing in an image captured by the image capturing means and recognizes the character(s);
a Braille converting means which converts a part of or all the characters recognized by the character recognition means to Braille; and
a display control means which displays the Braille converted by the Braille converting means on the Braille display unit,
wherein the Braille display unit includes multiple single Braille display units each corresponding to one Braille character;
wherein each single Braille display unit includes multiple movable members; and
wherein the display control means displays whether or not the relative position of the handheld Braille converting device is correct with respect to a character or character string existing in the captured image, by operating members included in a part of the single Braille display units, and displays Braille by operating members included in the other single Braille display units.

11. (canceled)

12. The handheld Braille converting device according to claim 2,
wherein the display control means indicates the presence/absence of character(s) in the captured image, by operating the members included in the part of the single Braille display units.

13. The handheld Braille converting device according to claim 3,
wherein the display control means indicates the presence/absence of character(s) in the captured image, by operating the members included in the part of the single Braille display units.

14. The handheld Braille converting device according to claim 2,
wherein the display control means indicates whether the character string existing in the captured image is written vertically or horizontally, by operating the members included in the part of the single Braille display units.

15. The handheld Braille converting device according to claim 3,
wherein the display control means indicates whether the character string existing in the captured image is written vertically or horizontally, by operating the members included in the part of the single Braille display units.

16. The handheld Braille converting device according to claim 4,
wherein the display control means indicates whether the character string existing in the captured image is written vertically or horizontally, by operating the members included in the part of the single Braille display units.

17. The handheld Braille converting device according to claim 2,
wherein the display control means indicates a direction of an initial character of the character string existing in the captured image, by operating the members included in the part of the single Braille display units.

18. The handheld Braille converting device according to claim 3,
wherein the display control means indicates a direction of an initial character of the character string existing in the captured image, by operating the members included in the part of the single Braille display units.

19. The handheld Braille converting device according to claim 4,
wherein the display control means indicates a direction of an initial character of the character string existing in the captured image, by operating the members included in the part of the single Braille display units.

20. The handheld Braille converting device according to claim 5,
wherein the display control means indicates a direction of an initial character of the character string existing in the captured image, by operating the members included in the part of the single Braille display units.

21. The handheld Braille converting device according to claim 2,
wherein the display control means displays whether or not the relative position is correct by lifting up and lowering the members included in the part of the single Braille display units to form the convex shapes while vibrating the members, and displays Braille by lifting up and lowering the members included in the other part of the single Braille display units to form the convex shapes.
